(19) United States
(12) Patent Application Publication
(10) Pub. No.: US 2017/0028579 A1
(43) Pub. Date: Feb. 2, 2017

(54) CUTTING DEVICE

(71) Applicant: MAGNA STEYR Fuel Systems GesmbH, Sinabelkirchen (AT)

(72) Inventors: Mario DREBES, Berlin (DE); Bernhard SPARY, Nestelbach bei Graz (AT)

(21) Appl. No.: 15/224,545

(22) Filed: Jul. 30, 2016

(30) Foreign Application Priority Data
Jul. 30, 2015 (EP) 15179052.4

(51) Int. Cl. B26D 1/14; B26D 7/06

(52) U.S. Cl. CPC B26D 1/14; B26D 7/0625

(57) ABSTRACT

A cutting device for cutting off pieces from a strip of material, and a device for producing plastic pieces, and which includes at least one cutting device.

### CROSS-REFERENCE TO RELATED APPLICATIONS

The present application claims priority 35 U.S.C. §119 to European Patent Publication No. EP 15179052.4 (filed on Jul. 30, 2015), which is hereby incorporated by reference in its entirety.

### TECHNICAL FIELD

Embodiments relate to a cutting device configured to cut off or otherwise remove pieces from a strip, and to a device for producing plastic pieces. The cutting device in accordance with embodiments is particularly suitable for cutting off individual sheets from an extruded, hot plastic strip that is drawn off from a die of an extruder via a conveyor belt.

### BACKGROUND

Cutting devices are suitable, in particular, for cutting off individual pieces from a strip, such as an endless strip, that is transported on a conveyor belt. Such cutting devices may be used in the paper, textile, and plastic industries.

### SUMMARY

Embodiments relate to a cutting device, and a device for producing plastic pieces that comprises such a cutting device, and that enables pieces to be cut from a conveyed strip in a flexible and reliable manner.

In accordance with embodiments, a cutting device for cutting off pieces from a strip, comprises a cutter unit having a rotatably mounted disc blade, which may be made to rotate by a drive for the purpose of cutting, a conveyor unit to convey the strip in a longitudinal direction, and a guide unit having an actuator, the cutter unit being guidable in the longitudinal direction via the guide unit, and guidable in a transverse direction that is perpendicular to the longitudinal direction via the actuator on the guide unit.

In accordance with embodiments, a strip can be conveyed in a longitudinal direction by a conveyor unit, for example, a conveyor belt.

In accordance with embodiments, the cutter unit can likewise be moved in the same longitudinal direction, and thus, guided over the strip, for example, at the same velocity as the conveyor unit, such that in segments the cutter unit would be stationary over the same position of the strip.

In accordance with embodiments, the cutter unit can be guided over the strip in a transverse direction, i.e., usually along the width of the strip, such that, with a synchronized velocity of the conveyor unit and the guide unit, a straight cut along the running strip can be produced, or a predefined, curved cut line. For the purpose of cutting, the cutter unit has a rotating disc blade, i.e., a disc-shaped element having a cutting edge realized on the outer circumference of the disc, to enable optimal parting of the strip material, in particular a hot, extruded plastic.

In accordance with embodiments, a device for producing plastic pieces may comprise at least one extruder having a die, and at least one cutting device having a cutter unit with a rotatably mounted disc blade, which may be made to rotate by a drive for the purpose of cutting, the cutting device being designed such that an extruded plastic strip that is output through the die can be conveyed to the cutter unit via the conveyor unit.

In accordance with embodiments, the cutter unit comprises a blade carriage for receiving the disc blade, the blade carriage being movable in a transverse direction along a guide profile of the guide unit.

In accordance with embodiments, the guide unit comprises a chain carriage and a base plate that is not movable with the chain carriage, the chain carriage comprising a chain tensioned between two sprocket wheels, the chain being fixed to the base plate of the guide unit, at a first position. The term “chain” in accordance with embodiments may include chains of any type, and also includes chain-type devices such as, for instance, belts.

In accordance with embodiments, the blade carriage is fixed to the chain, at a second position, the second position being disposed on the strand of the chain that is opposite the first position, such that the second position is separated from the first position on both sides by sprocket wheels.

In accordance with embodiments, the chain carriage can be moved in a transverse direction by the actuator on the guide unit.

In accordance with embodiments, the guide profile may be fixed to the chain carriage, but can also be fixed to the base plate.

In accordance with embodiments, the guide unit is suspended so as to be rotatable about an axis that is perpendicular to the strip, i.e., usually a vertical axis.

In accordance with embodiments, the cutting device comprises a control unit, such that the velocity of the conveyor unit and/or the motion of the cutter unit in the longitudinal direction and/or in the transverse direction, and/or a rotation of the guide unit about a vertical axis that is perpendicular to the strip, can be predefined by the control unit.

In accordance with embodiments, the drive of the disc blade may be constituted by a rack and a pinion that meshes in the rack and that is rotationally solid with the disc blade. The rotary motion of the blade can then be achieved, without its own drive, by the linear motion of the cutter unit. For this purpose, the rack is fixed in respect of the guide unit, in particular in respect of the base plate of the guide unit.

In accordance with embodiments, the drive of the disc blade may also be realized by a motor that directly drives the disc blade.

In accordance with embodiments, the cutter unit has a shoe with a cutting edge opposite the disc blade. The disc blade can be biased, via a contact pressure spring, in the direction towards the cutting edge of the shoe.

In accordance with embodiments, the cutter unit, in particular, if appropriate, the shoe of the cutter unit, may have at least one air nozzle, in order to detach the strip from the conveyor unit.

In accordance with embodiments, the cutter unit, in particular, if appropriate, the shoe of the cutter unit, may have two or more air nozzles, in order to detach the strip from the conveyor unit.

In accordance with embodiments, the disc blade is aligned in the transverse direction and/or is alignable in the transverse direction, and/or a vertical pitch angle (bevel angle) of the disc blade can be set in respect of the conveyor unit.

In accordance with embodiments, the disc blade may have a round, fluted or toothed design, and/or has saw teeth, and/or is of a rotationally symmetrical design, and/or has the shape of a polygon, in particular a regular polygon, for example, hexagonal or octagonal.

### DRAWINGS

Embodiments will be illustrated by way of example in the drawings and explained in the description below.

FIG. 1 illustrates a side view of a cutting device, in accordance with embodiments.

FIG. 2 illustrates a top view of the cutting device of FIG. 1.

FIG. 3 illustrates a chain carriage and a blade carriage of a cutting device, in accordance with embodiments.

FIG. 4 illustrates a perspective view of a part of a cutting device, in accordance with embodiments.

FIG. 5 illustrates a perspective view of a part of a cutting device, in accordance with embodiments.

FIG. 6 illustrates a perspective view of a part of a cutting device, in accordance with embodiments.

FIG. 7 illustrates a perspective view of a part of a cutting device, in accordance with embodiments, the cutter unit 2 being represented in section.

FIG. 8 illustrates possible disc blades for a cutting device, in accordance with embodiments.

### DESCRIPTION

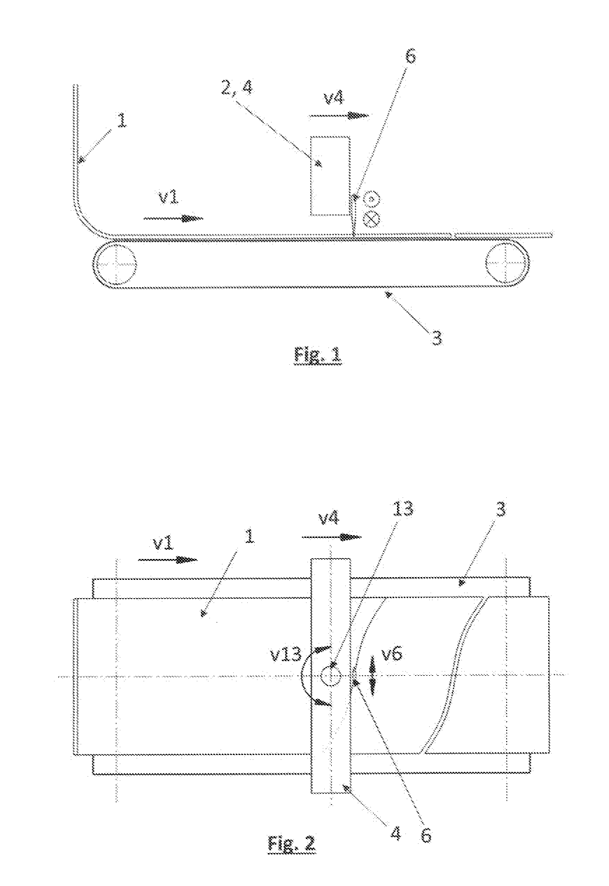

FIGS. 1 and 2 illustrate a schematic arrangement of a cutting device during a cutting process, in accordance with embodiments.

The cutting device may be used to cut off or otherwise remove pieces from a strip 1 of material/workpiece, and comprises a cutter unit 2, a conveyor unit 3 for conveying the strip 1 in a longitudinal direction, and a guide unit 4. The cutter unit 2 may be guidable in the longitudinal direction (along v4) via the guide unit 4, and in a transverse direction (along v6) that is perpendicular to the longitudinal direction on the guide unit 4.

The strip velocity v1 of the strip 1 and the guide unit velocity v4 of the guide unit 4 may be operatively linked to each other, for example, via a control unit. In accordance with embodiments, in the simplest form, the strip velocity v1 and the guide unit velocity v4 are equal, i.e., synchronized.

FIG. 2 illustrates a top view of the arrangement of FIG. 1. The cutter unit 2 of the cutting device is suspended so as to be rotatable under control about a vertical axis 13. The strip 1 can be guided along the entire device via the conveyor unit 3. The disc blade 6 of the cutter unit 2 is movable along the cutting device, likewise controlled by a control unit. If the three motions of the device, namely, v4 (velocity of the guide unit 4 in the longitudinal direction), v6 (velocity of the disc blade 6 in the transverse direction), and v13 (angular velocity of the guide unit 4 about the normal axis 13) are coordinated with the velocity of the strip v1, a desired curved cutting line can be obtained.

If the velocity of the device just corresponds to the velocity of the guide unit 4, i.e., v13=0 and v4=v1, then a straight cut in the transverse direction is obtained. The velocities for other curves can be calculated, and can be implemented by a control unit.

It would be possible to represent v4 and v13 each with their own drive, but preferably these two motions are generated via a common drive.

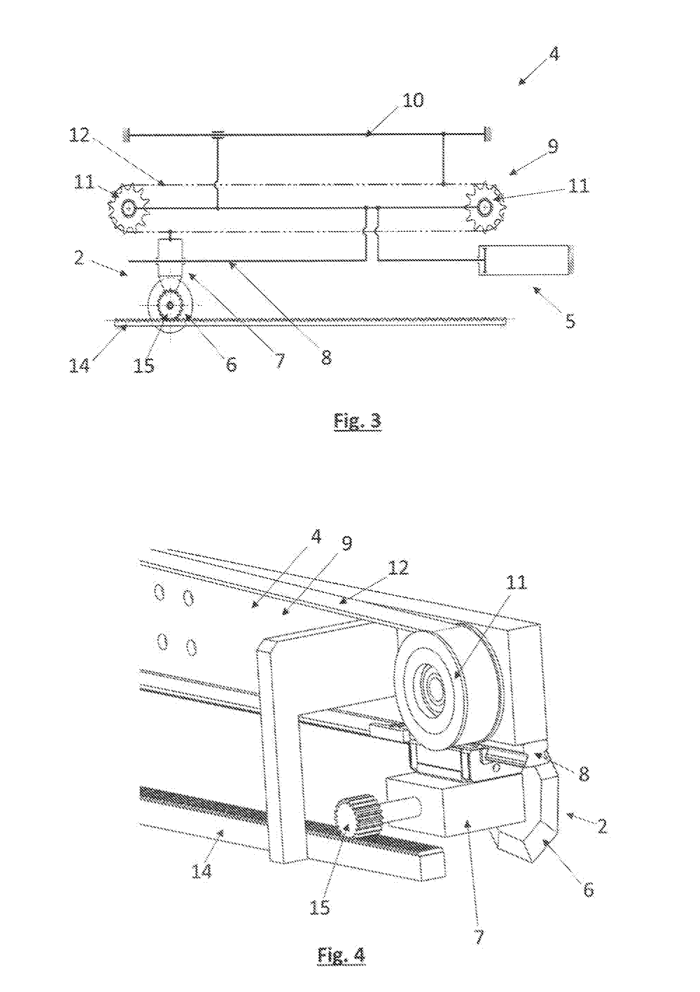

FIG. 3 illustrates the basic structure of the cutting device, in particular the guidance of the chain carriage 9 and of the blade carriage 7. The sprocket wheels 11, with the chain 12, are mounted on the chain carriage 9. The latter is moved by an actuator 5. The chain 12 at the top is fixed to the base plate 10. The blade carriage 7, with the disc blade 6, is connected to the chain 12 at the bottom, and moves along a guide profile 8 that is attached to the chain carriage 9 (the guide profile 8 could also be attached to the base plate 10). When the actuator 5 is actuated, the disc blade 6 runs at double velocity, and therefore also travels double the distance. It is thereby possible to use an actuator 5 having a stroke half as long as without a structure having a chain carriage 9.

In accordance with embodiments, although the carriages 7, 9 are illustrated as driven by a single actuator, embodiments are not limited thereto. For example, the carriages 7, 9 could be driven via separate actuators (the chain 12 then need not be attached to the base plate 10).

FIG. 4 illustrates the design of the blade carriage 7. The blade carriage 7 uses a rotatable disc blade 6, which can be made to rotate by a drive, for the purpose of cutting. The outer circumference of the disc blade 6 is realized as a cutting edge. This type of rotating blade is known, for example, from the foodstuffs industry (“pizza cutting”) and the textile industry. The rotating disc blade allows optimal initial cutting into the strip material 1. Since, for example, the surface of an extruded strip forms a semi-solid skin with the ambient air as a result of cooling, the rotating disc blade 6 is advantageous in effecting an initial cut.

The rotating disc blade 6 may be driven directly by a motor, but preferably it is driven, as represented in FIGS. 3 to 7, via a pinion 15, which rolls on a rack 14 that is fixed to the frame, or to the base plate 10. If the disc blade 6 is directly driven, the pinion 15 and rack 14 are omitted; however, this requires the mounting of a drive motor. The latter runs in synchronism with the guide unit 4; the electric or pneumatic energy supply must likewise be in synchronism. For this reason, the solution comprising the pinion 15 and rack 14 is preferred. The size of the pinion 15 determines the rotational speed of the disc blade 6. The size of the pinion 15 is limited by the space available above the strip 1 and the diameter of the shaft used.

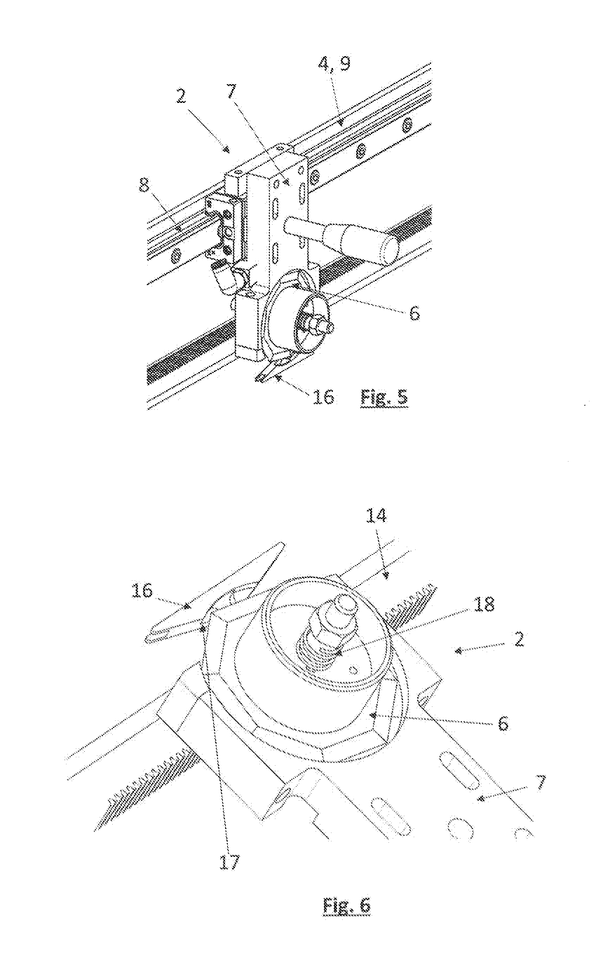

As illustrated in FIGS. 5 and 6, the shoe 16 may be disposed beneath the rotating disc blade 6, in order to prevent the strip 1 from moving out of place.

FIG. 6 illustrates a 3D representation of the cutter unit 2. The blade 6 may be pressed against the wall of a recess in the shoe 16 by a contact pressure spring 18. The recess has a sharp edge that functions as a second cutting edge 17. As a result, the material of the strip is parted, not only via pressure, but by the principle of a pair of shears. For this reason, also, an arrangement comprising a shoe 16 is preferred. Clearly, all of these elements, in particular the two cutting edges, are hardened. The parts that come into contact with the strip material 1 may be provided with an anti-stick coating to prevent sticking to the conveyor unit 3.

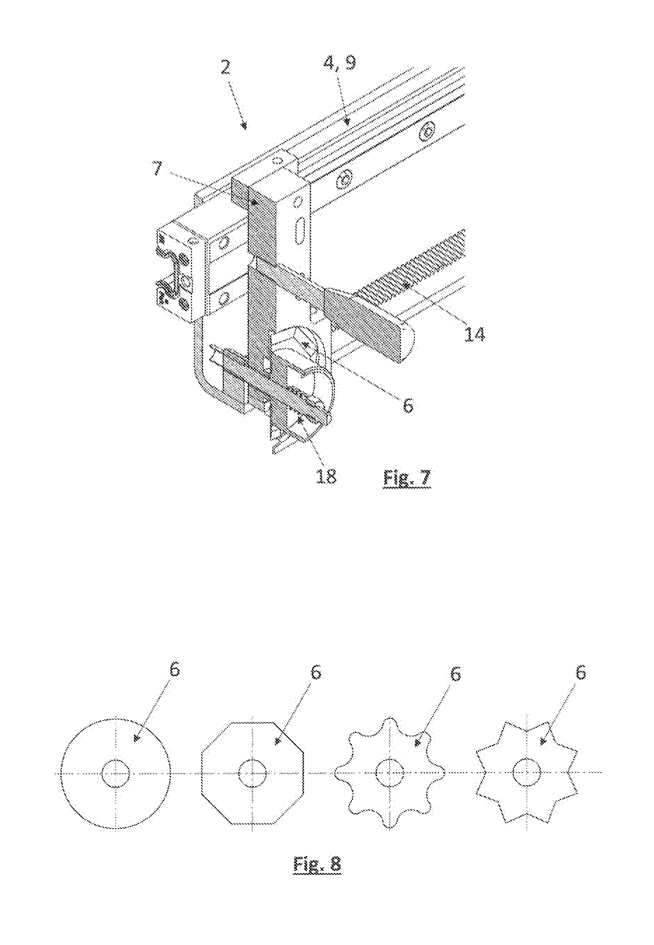

FIG. 7 illustrates a section through the cutter unit 2.

FIG. 8 illustrates a selection of various possible shapes of the disc blade 6, namely, circular, polygonal, in this case octagonal, fluted and toothed, or star-shaped, each being of a symmetrical design. Not illustrated here, but likewise possible, would be fluted or toothed profiles of an asymmetrical design, for example asymmetrical saw teeth. Only the use of a disc blade 6 of symmetrical design is appropriate for cutting in a forward and return direction.

A fluted or toothed design of the disc blade 6 is advantageous in effecting the initial cut into a strip 1. The teeth “draw” the material to the cutting edges, and consequently in this case the strip 1 is less likely to buckle. Circular and polygonal disc blades 6 allow easier resharpening of the respective cutting edge.

The term “coupled” or “connected” may be used herein to refer to any type of relationship, direct or indirect, between the components in question, and may apply to electrical, mechanical, fluid, optical, electromagnetic, electromechanical or other connections. In addition, the terms “first,” “second, etc. are used herein only to facilitate discussion, and carry no particular temporal or chronological significance unless otherwise indicated.

This written description uses examples to disclose the invention, including the preferred embodiments, and also to enable any person skilled in the art to practice the invention, including making and using any devices or systems and performing any incorporated methods. The patentable scope of embodiments is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. Aspects from the various embodiments described, as well as other known equivalents for each such aspects, may be mixed and matched by one of ordinary skill in the art to construct additional embodiments and techniques in accordance with principles of this application.

### LIST OF REFERENCE SIGNS

1 strip

2 cutter unit

3 conveyor unit

4 guide unit

5 actuator

6 disc blade

7 blade carriage

8 guide profile

9 chain carriage

10 base plate

11 sprocket wheel

12 chain

13 axis perpendicular to the conveyor unit

14 rack

15 pinion rotationally solid with the disc blade

16 shoe

17 cutting edge

18 contact pressure spring

v1 velocity of the strip (longitudinal direction)

v4 velocity of the guide unit (longitudinal direction)

v6 velocity of the disc blade (transverse direction)

v13 angular velocity of the guide unit about the axis

What is claimed is:

1. A cutting device, comprising:
a cutter unit having a rotatably mounted disc blade configured to rotate for the purpose of cutting an extruded strip of material;
a conveyor unit to convey, in a longitudinal direction, the extruded strip of material to the cutter unit; and
a guide unit having an actuator to guide the cutter unit relative to the conveyor in the longitudinal direction, and a transverse direction that is perpendicular to the longitudinal direction.

2. The cutting device of claim 1, wherein the cutter unit comprises a blade carriage to receive the disc blade, the blade carriage being movable in the transverse direction along a guide profile of the guide unit.

3. The cutting device of claim 2, wherein the guide unit comprises a chain carriage and a base plate that is not movable with the chain carriage, the chain carriage having a chain between sprocket wheels, the chain being fixed to the base plate, at a first position.

4. The cutting device of claim 3, wherein the blade carriage is fixed to the chain, at a second position, the second position being disposed on a strand of the chain that is opposite the first position.

5. The cutting device of claim 3, wherein the chain carriage is movable in the transverse direction by the actuator on the guide unit.

6. The cutting device of claim 3, wherein guide profile is fixed to the chain carriage.

7. The cutting device of claim 3, wherein guide profile is fixed to the base plate.

8. The cutting device of claim 1, wherein the guide unit is mounted for suspension so as to be rotatable about an axis that is perpendicular to the conveyor unit.

9. The cutting device of claim 1, further comprising a controller to control the cutter unit and the conveyor unit such that a velocity of the conveyor unit and/or the velocity of the cutter unit in the longitudinal direction and/or in the transverse direction, and/or a rotation of the guide unit about a vertical axis that is perpendicular to the extruded strip of material, is predefined by the controller.

10. The cutting device of claim 1, wherein the drive of the disc blade is constituted by a rack and a pinion that meshes in the rack and that is rotationally solid with the disc blade.

11. The cutting device of claim 1, wherein the drive of the disc blade is constituted by a motor that directly drives the disc blade.

12. The cutting device of claim 1, wherein the cutter unit has a shoe having a cutting edge opposite the disc blade.

13. The cutting device of claim 12, wherein the shoe comprises at least one air nozzle to detach the extruded strip of material from the conveyor unit after cutting by the cutter unit.

14. The cutting device of claim 12, further comprising a contact pressure spring to bias the disc blade in a direction towards the cutting edge of the shoe.

15. The cutting device of claim 1, wherein the cutter unit comprises at least one air nozzle to detach the extruded strip of material from the conveyor unit after cutting by the cutter unit.

16. The cutting device of claim 1, wherein the disc blade is configured to be alignable in the transverse direction with respect to the conveyor unit.

17. The cutting device of claim 1, wherein a vertical pitch angle of the disc blade is configured to be set with respect to the conveyor unit.

18. A cutting device, comprising:
a cutter unit having a rotatably mounted disc blade configured to rotate for the purpose of cutting an extruded strip of material, and a shoe having a cutting edge opposite the disc blade;
a conveyor unit to convey, in a longitudinal direction, the extruded strip of material to the cutter unit; and
a guide unit having an actuator to guide the cutter unit relative to the conveyor in the longitudinal direction, and a transverse direction that is perpendicular to the longitudinal direction,
wherein the shoe has at least one air nozzle to detach the extruded strip of material from the conveyor unit after cutting by the cutter unit.

19. A device for producing plastic pieces, comprising:
at least one extruder for extruding a strip of material, the extruder having a die through which the strip of material is extruded; and
at least one cutting device having:
a cutter unit having a rotatably mounted disc blade configured to rotate for the purpose of cutting the extruded strip of material;
a conveyor unit to convey, in a longitudinal direction, the extruded strip of material to the cutter unit; and
a guide unit having an actuator to guide the cutter unit relative to the conveyor in the longitudinal direction, and a transverse direction that is perpendicular to the longitudinal direction.
